(19) United States
(12) Patent Application Publication
(10) Pub. No.: US 2024/0012232 A1
(43) Pub. Date: Jan. 11, 2024

(54) Secondary Reflector

(71) Applicant: Fangming HU, Huaian, Jiangsu (CN)

(72) Inventor: Fangming HU, Huaian, Jiangsu (CN)

(21) Appl. No.: 18/019,809

(22) PCT Filed: Aug. 16, 2021
(86) PCT No.: PCT/CN2021/112871

§ 371 Date: Feb. 5, 2023

(30) Foreign Application Priority Data
Aug. 15, 2020 (CN) 202010822032.5
Sep. 4, 2020 (CN) 202010918259.X
Dec. 15, 2020 (CN) 202011476018.0

(51) Int. Cl. G02B 23/08

(52) U.S. Cl. CPC G02B 23/08

(57) ABSTRACT

A secondary reflector composed of two reflectors and a fixing frame, which utilizes a principle that a distant object is imaged on eyes in a triangular form that an object image gradually narrows down from a wider range to a narrower range. According to change of width of a lights range of the object image on an observed object plane at reflection points, the reflectors with appropriate sizes are arranged at the reflection point. A sight line is perpendicular to a direction of the upper body; the second reflector (2) is located directly in front of the eyes in the sight line direction; the reflectors are fixed by a frame which is not supported on the body. For the secondary reflector, angles and positions of the reflectors are adjustable, and a reference included angle between the reflector (1) and the reflector (2) is set to 45 degrees.

### CROSS REFERENCE TO RELATED APPLICATION

This application is a national stage application of International Patent Application No. PCT/CN2021/112871, filed on Aug. 16, 2021, which claims priority of the Chinese Patent Application No. CN202010822032.5, filed on Aug. 15, 2020, Chinese Patent Application No. CN202010918259.X, filed on Sep. 4, 2020, Chinese Patent Application No. CN202011476018.0, filed on Dec. 15, 2020, all of which are incorporated by references in their entities.

### TECHNICAL FIELD

The present invention relates to a reflector, in, particular to a secondary reflector.

### BACKGROUND ART

People often need to keep looking down, bending down and lowering heads for a long time in work and life, which seriously affects their health. On Jan. 16, 2014, an optical view field converter was published, with the application publication No. CN103728716A and the application No. 201410039862.5, which is a secondary reflector worn in front of eyes, and realizes a change from looking down to looking at the front horizontally.

### SUMMARY

### TECHNICAL PROBLEM

In the prior art, only a range of a few centimeters can be observed. If the range needs to be enlarged, a reflector must be enlarged and zoomed out, or a neck posture must be adjusted, which cannot be realized due to somatosensory limitations, and a directly forward sight view that meets comfortable watching of people is blocked, which not only makes it difficult to improve watching comfort, but also causes serious discomfort.

### TECHNICAL SOLUTION

A secondary reflector composed of two reflectors and a fixing frame, which utilizes a principle that a distant object is imaged on eyes in a triangular form that an object image is gradually narrows down from a wider range to a narrower range, the reflectors are arranged on an incidence path of lights to change a propagation direction of lights of the object image; the lights of the object image (FG) first strike on a part (AE) of the reflector (1), and are reflected by the reflector (1) to a part (BC) of the reflector (2) and then are reflected by the reflector (2) to an observation point (A); and according to change of a width of a light range of the object image on an observed object plane at reflection points, the reflectors with appropriate sizes are arranged at the reflection points. Further, the reflectors are plane mirrors. Further, an observer's upper body maintains a straight posture, including but not limited to sitting, standing, leaning and lying; a sight line is perpendicular to a direction of the upper body; an observed object plane is located vertically and directly below the sight line direction with a body as a reference; the reflector (1) is located directly above the observed object plane in a vertical projection range of a plane in which center sight lines of two eyes are located, with the body as a reference; and the reflector (2) is located directly in front of the eyes in the sight line direction. Further, the reflectors are fixed by a frame which is not supported on the human body. Further, for the secondary reflector, angles and positions of the reflectors are adjustable. A reference included ange between the reflector (1) and the reflector (2) is set to 45 degrees.

As proved: as shown in FIG. 2, CB and ED extend to intersect at a point 0; an optical path from the center sight line AH to the object plane is restored; a symmetrical straight line HI of AH relative to CB is made and extended to intersect with ED at a point J; a symmetrical straight line of IJ relative to ED is made and extended downward to intersect with AH at a point L and intersect with FG at a point M; and FIG. 2-a is obtained;

The sight line is perpendicular to the direction of the upper body, so that the observed object plane is located directly below the direction of the sight line with the body as a reference, that is, the horizontal sight line AH is perpendicular to a reflected sight line LM perpendicularly directly below the horizontal sight line; and any sight line AB is perpendicular to a reflected sight line NF, that is, ∠BND=90° ;
∠OBD=∠ABC, so 2∠OBD+∠DBN=180° ;
∠ODB=∠EDF, so ∠ODB+∠BDN=180° ; ∠DBN+∠BDN=90°,
so 2 ∠OBD+∠DBN+2∠ODB+∠BDN=360°=2∠OBD+2∠ODB+90°;
so ∠OBD+∠ODB=135°;
so ∠EOC=45°, that is, the included angle between the reflector 1 ED and the reflector 2 BC is 45°.

The secondary reflector is provided with a light source or a reflected light source in an imaging direction of the observed object plane, so that the object plane faces towards a visual imaging direction. Further, a light direction of the light source is designed to be reflected to the eyes by the secondary reflector, but not directly goes to the eyes. Further, an illuminating device is installed by the fixing frame. The fixing frame includes a reflector connecting frame. Further, the reflector connecting frame connects and fixes the two reflectors together. The fixing frame for the reflectors is provided with a supporting device that supports the reflector connecting frame to a required position. Further, the supporting device includes, but is not limited to a base-type supporting frame, a wall supporting frame and a supporting frame relying on an associated device. The fixing frame includes a visual object frame. Further, the visual object frame is fixed at the position of the observed object plane and used for placing computers, books, mobile phones and the like.. The fixing frame is provided with a light isolation device around and on both sides of the reflector 2. Further, the light isolation device blocks the lights which do not come from the reflector 1 and the observation point direction. A dust cover is arranged on a mirror surface of each reflector. Further, the dust cover slides along a fixed track to expose the reflector or cover the reflector. The fixing frame is provided with a cleaning device on the mirror surface of the reflector. Further, the cleaning device slides along the track for cleaning.

A dual-reflector assembly composed of a front reflector (1), a rear reflector (2) and a connecting fixing member, and includes a seat-type fixing device and method for fixing on a base-type fixing device, a front fixing device and method for fixing on a wall or other fixed support structures, a rear fixing device and method for fixing on a back of a bed or a sofa or other fixed support structures, a top fixing device and method for fixing on a top in a car, and a shoulder-back type device and method by using a lightweight reflector material and a connecting fixing member. The seat-type fixing device and method includes one-side fixing of a desk-lamp-type base, two-side fixing bases with two symmetrical sides, and an annular fixing base with a plurality of pairs of reflectors (1) and (2) fixed together around for use by a plurality of people around. The front fixing device and method includes a front fixing frame 3, and further, the front fixing frame 3 is fixed to a fixing clip on a wall. The rear fixing device and method includes a rear fixing frame 4, and further, the fixing frame 4 includes an adjusting device, which includes the telescopic adjustment and rotational adjustment of the secondary reflector, and can realize adjustment of a relative position of the reflectors with respect to a person., and further, the fixing frame has a function of unfolding the secondary reflector. According to the top fixing device and method, the device is fixed on the top above an instrument panel and the top of each passenger seat, so as to realize reading and watching of a mobile phone in a car without lowering a head. The shoulder-back-type fixing device and method includes fixing reflectors in the front of a person. The device is integrated with cooking utensils to realize cooking while looking at the front horizontally. The device has a function of being folded and retracted, and further, the reflectors, a front fixing rod, a rear fixing rod and a vertical supporting base can all be folded, and further, the folding includes electric folding and manual folding.

The secondary reflector is characterized in that a reference position is set in such a way that the observation point is located near a position below a lower end point of the reflector (1); and lines connecting upper and lower end points of the reflector (2) and the observation point form a golden section triangle, i.e., a line connecting the observation point to the lower end point is perpendicular to the reflector (2) and has a length twice as long as that of the reflector (2).

As proved: as shown in FIG. 2, in order to maximize a use rate of the reflector and reach the shortest reflected optical path, a theoretical position of the viewpoint must be located at the lower end point of the reflector 1, that is, the viewpoint A is located at the lower end point of the reflector 1.

Because the reflectors with an appropriate sizes are arranged at reflection points, lights entering the upper end point of the reflector (1) are just reflected to the upper end point of the reflector (2) and then reflected into the viewpoint; and lights entering the lower end point of the reflector (1) are just reflected to the lower end point of the reflector (2), and then reflected into the viewpoint.

An included angle between the reflector (1) AE and the reflector (1) CB intersects at a point D. Because a path from the lower end point C of the reflector (2) to the viewpoint A is that lights entering the viewpoint A from the object plane are reflected out, then enter the reflector (2) and are then reflected back to the viewpoint, an incidence path can only be perpendicular to the reflector (2) and coincide with a reflection path.

Moreover, the path perpendicular to the reflector (2) is a path of the maximum view angle at the lower end. Because the reflection point of the reflector (1) entering the reflector (2) must be located behind and below the viewpoint A, and the viewpoint falls into the reflector (1) if the path of reflection from the reflector (2) into the viewpoint is below a perpendicular foot C point, it is impossible.

The path CA to the viewpoint is mirror symmetrized with the CB to obtain the viewpoint outward reflection path AI; the AI is mirror symmetrized with the reflector (1) AE to obtain the incidence path AH entering the reflector (1); and the lower end point C of the reflector (2) is connected to a vertex H of an incident virtual image to obtain the maximum view angle ∠CHA. Because HA=AI=2AC, and ∠CAE=∠D=45°, ∠HAC=2 ∠CAE=90°. Hence, ΔHAC is a golden cut triangle. ΔACB˜HAC, so ΔACB is a golden cut triangle and AC=2BC.

In the secondary reflector, the reflector (1) and the reflector (2) are respectively designed as curved mirrors, so that the lights on the object plane change the linear change of the light by one of the reflectors, and then adjust the non-linearity of the lights by the other reflector. Therefore, the lights on the object plane are reflected to the observation point with linear changes, thereby realizing imaging of the object plane without deformation at the observation point.

### BENEFICIAL EFFECTS

During reading and writing, a healthy watching distance can be maintained; eyesight is protected; head lowering is not needed; cervical spine health is protected; electronic display equipment is operated and watched without head lowering, so as to protect cervical spine health; and bending down and head lowering are not needed during cooking, thereby protecting cervical spine health and improving the quality of life.

### BRIEF DESCRIPTION OF THE DRAWINGS

FIG. 1 is a schematic diagram of a secondary reflector, and FIG. 1-a is a schematic diagram of auxiliary optical path derivation in FIG. 1.

FIG. 2 is a schematic diagram of a reference position of the secondary reflector.

FIG. 3 is a schematic diagram of a principle of the curved secondary reflector.

FIG. 4 is a structural schematic diagram of the secondary reflector and a fixing frame.

FIG. 5 is a schematic diagram of the secondary reflector and a connecting frame.

FIG. 6 is a schematic diagram of a supporting device of the secondary reflector. FIG. 7 is a schematic diagram of a visual object frame of the secondary reflector.

FIG. 8 is a schematic diagram of a light isolation device.

FIG. 9 is a schematic diagram of a principle of the secondary reflector.

Brief descriptions of FIG. 3: lights on an object plane are reflected to BC by DE, and then reflected to a observation point A; DE is a convex mirror; BC is a concave mirror; and an radian of arc of BC is equal to that of DE.

### DETAILED DESCRIPTION OF THE EMBODIMENTS

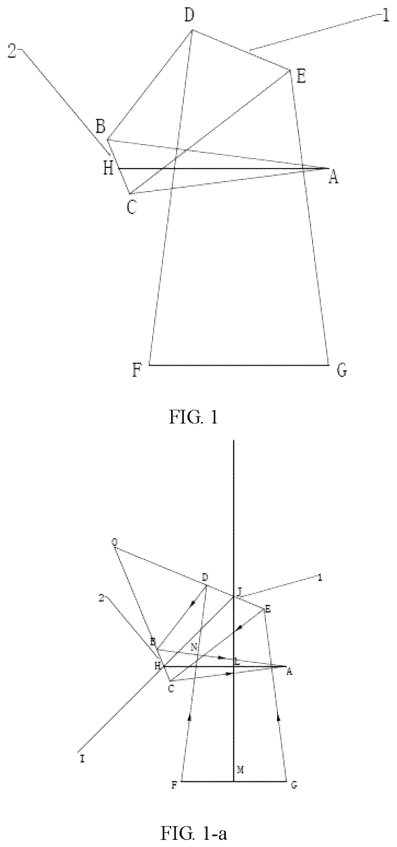

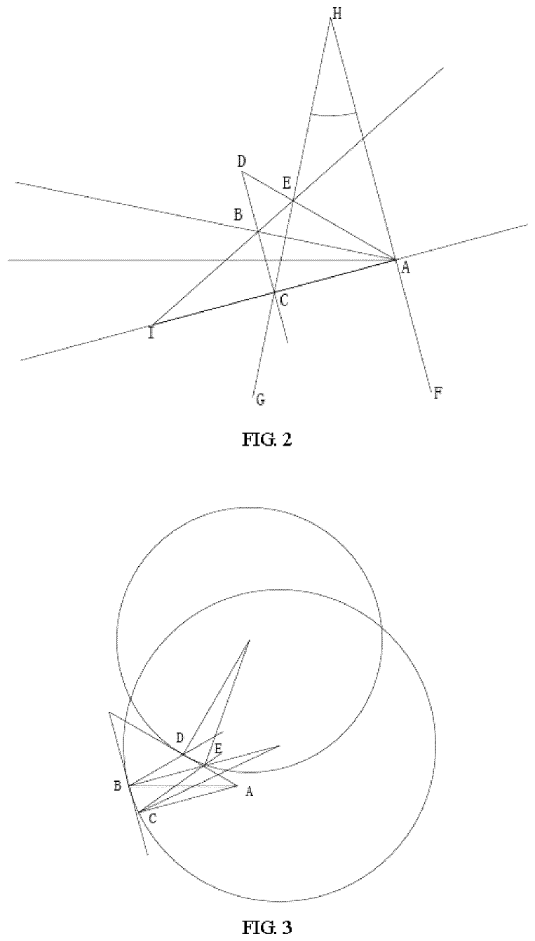

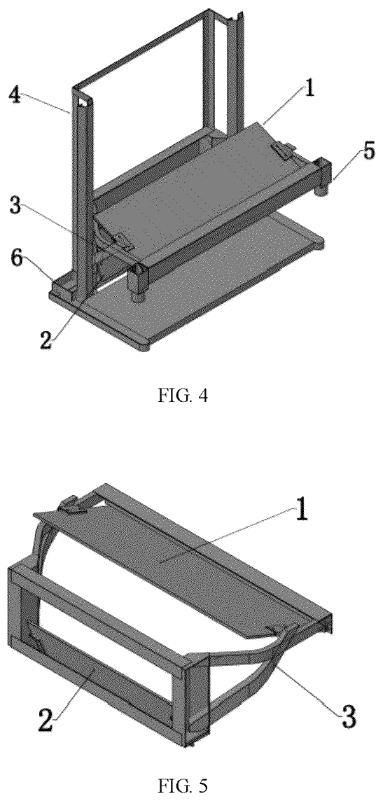

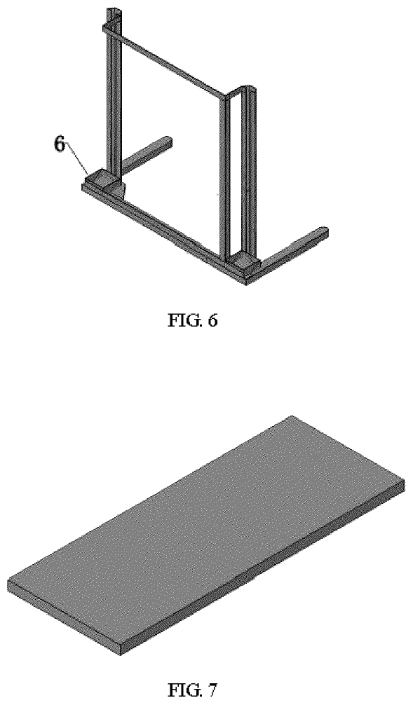

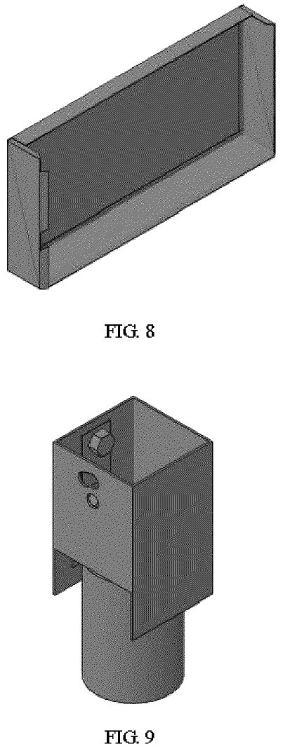

The present embodiment is one of embodiments of the present invention, and does not limit the protection scope of the present invention. As shown in FIG. 4, 1 refers to a reflector; 2 refers to a reflector 2; 3 refers to a connecting frame; 4 refers to a supporting device; 5 refers to an illuminating device; 6 refers to a storage box. The secondary reflector is fixed on a fixing frame; the first reflector 1 is fixed directly above a visual object frame; and the reflector 2 is fixed directly in front of an observation point. The fixing frame comprises the connecting frame 3 and the supporting device 4; both ends of the reflector 1 and the reflector 2 are connected to and fixed on both sides of the connecting frame through screw rods respectively; and an axis of each screw rod is arranged at a reflection line of a horizontal center sight line at a mirror surface. As shown in FIG. 1, the horizontal center sight line is AH. FIG. 1 is a side view, AH is actually a horizontal plane intersected with the reflector 2 in a straight line, i.e., a point H, so that the point H is actually a horizontal straight line located at the reflector 2. That is, the horizontal center sight line is located at the reflection line of the reflector 2. The reflection line of AH relative to the reflector 1 is made by passing the point H; and an intersection point with the reflector 1 is taken. The intersection point, that is, the reflection line position of the reflector 1 where the horizontal center sight line is located, can adjust a reflection range by rotating the mirror surfaces around the direction of the screw rods. The screws are loosed to adjust rotation of the reflector, and are tightened to fix the reflector after proper observation and adjustment. As shown in FIG. 1, the reflectors with appropriate sizes are arranged at the reflection points; the point H is located on a horizontal line of looking at the front horizontally; upper and lower angles of a field of view are approximately equal, that is, under conventional situations, AH is located on a bisector of upper and lower angles of the visual field; and angles of angle deflection of the reflector 2 in the vertical direction and angle deflection of the reflector 1 in the horizontal direction are both small, so that the horizontal center sight line of the reflector 1 and the reflector 2 is near the gravity axis of the reflectors. Thus, fixing can be realized easily by single-axis screws at both ends. The light source of the illuminating device is fixed on the front end of the connecting frame, and the height is equivalent to the bottom edge of the reflector 1. The reflector 1 and reflector 2 are connected together by the connecting frame. A light isolation device is fixed to the rear of the connecting frame and around the reflector 2. Glass wipes are arranged at the left ends of the reflector 1 and the reflector 2 respectively, and the wiping surfaces of the glass wipes have a length the same as the widths of the reflectors and fit on the mirror surfaces of the reflectors. That is, the glass wipers have the upper ends flush with the upper ends of the reflectors, and the lower ends flush with the lower ends of the reflectors, which are conventionally elongated. The two ends of each glass wiper are provided with matched sliding devices which are clapped into grooves on both sides of the mirror surfaces and are slidable in the direction of the grooves, that is, the upper end is clamped in the groove on the upper side of the reflector, and the lower end is clamped in the groove on the lower side of the reflector. Circular guide rails, which are polished rods, are provided respectively on the back surfaces of the reflectors. That is, a smooth circular bar is provided on the back surface of the reflector 1, and a smooth circular bar is provided on the back surface of the reflector 2. The two ends of each circular guide rail are connected to the connecting frame at both ends respectively. That is, a left end of the circular guide rail at the back surface of reflector 1 is connected to the connecting frame at the left end of the reflector 1, the right end of the circular guide rail is connected to the connecting frame at the right end of the reflector 1, the left end of the circular guide rail at the back surface of the reflector 2 is connected to the connecting frame at the left end of the reflector 2, and the right end of the circular guide rail is connected to the connecting frame at the right end of the reflector 2. The circular guide rails each are matched with a matching slider, that is, a circular hole is provided in the middle of the slider that matches with the circular guide rail. After being installed, the slider is slidable freely along the circular guide rail. The push rods are respectively fixed to both sides of the sliders. The two ends of the push rods are connected with the two ends of the glass wipers. That is, the push rod at the upper side of the slider is connected to the upper end of the glass wiper, and the push rod at the lower side of the slider is connected to the lower end of the glass wiper. Pushing the sliders to slide along the guide rails such that the glass wipes move on the mirror surfaces, thereby realizing a function of cleaning the glass mirror surfaces. A folding curtain cloth cover is provided between the glass wipers and the fixing frame at the left end of the reflectors. That is, a folding curtain cloth cover is arranged between the glass wiper and the fixing frame at the left end of the reflector 1, and a foldable curtain cloth cover is arranged between the glass wiper and the fixing frame at the left end of the reflector 2. Sliding clips are provided on both sides of the cloth cover and clamped in guide rail grooves on both sides of the mirror surfaces. That is, the sliding clip at the upper side of the cloth cover is clamped in the guide rail groove at the upper side of the mirror surface, and the sliding clip at the lower side of the cloth cover is clamped in the guide rail groove at the lower side of the mirror surface. The glass wipers are pulled to unfold and fold the cloth cover. The glass wipers are pulled to drive the cloth covers to unfold, and the upper and lower slide clips slide along the upper and lower grooves respectively. When the glass wipers are pulled to the right end of the mirror surfaces, the mirror surfaces are covered, thus realizing a dustproof function.

The supporting device is y-shaped fixed bases which are symmetrically arranged on the bottom at both sides. Rear ends of the fixed bases at both sides are connected and fixed by L-shaped connecting rods. Vertical supporting rods are respectively fixed at the middle and the rear above the bases at both sides. Connecting plates are arranged around the bottom of the vertical supporting rods for connection and fixation. Storage boxes are respectively arranged at both sides of each bottom connecting plate. Connecting plates are arranged at the tops of the vertical supporting rods at the rear of both sides for connection and fixation; and connecting plates are respectively arranged at the top of the front and rear vertical supporting rods on both sides for connection and fixation. Heightened vertical supporting rods are arranged, and can be fixed on the upper parts of the vertical supporting rods to increase a supporting height.

Both sides of the connecting frame are connected to and fixed on the vertical supporting rods or the heightened vertical supporting rods. Continuous screw holes are arranged on the supporting rods and the vertical supporting rods. The screw holes with an appropriate height can be selected at will to install the connecting frame, thereby realizing a height adjustment function of the secondary reflector.

### DETAILED DESCRIPTION OF PREFERRED EMBODIMENT

The present embodiment is one of the embodiments of the present invention, and the protection scope of the present invention is not limited to this. As shown in FIG. 5, the reflector 1 is directly arranged outside a tuyere of a range hood near a cooking person; and the reflector 2 is arranged between a cooking utensil on the inner side of the range hood and the range hood, and is connected with and fixed to the range hood via the frame 3. The lights of object image of cooking cookware having a path shown by the arrow in the diagram are reflected to come to the observation point A straightly, so that the cooking person can look at the front of the reflector 2 horizontally for cooking operations.

### INDUSTRIAL PRACTICALITY

The present invention solves health problems in work and life of people, and can be widely used in vegetable cutting, cooking, vegetable washing, reading and writing, computers, mobile phones, industrial manual operations and other aspects.

### FREE CONTENT IN SEQUENCE TABLE

Enter description paragraphs of free contents in the sequence table here.

We claim:

1. A secondary reflector, which is composed of two reflectors, follows a principle that the range of a distant object image gradually narrows from wide to a triangle and enters eyes, the reflector is set in the light incidence path to change the propagation direction of the object image; the object image (FG) first enters the (DE) part of the first reflector (1), is reflected by the first reflector (1) to the (BC) part of the second reflector (2), and is reflected into the viewpoint (A) by the second reflector (2), wherein according to the changing width of the light range of the object image at a reflection point, the reflector of appropriate size is set at the reflection point; further, the reflectors uses a plane mirrors; and further, the upper body of a observer maintains a straight posture, including but not limited to sitting, standing, leaning , lying, and the line of sight is perpendicular to the direction of the upper body; the observed object surface is located vertically right below the sight line direction with the body as a reference; the first reflector (1) is located right above the observed object surface in a vertical projection range of the plane where a center sight line of both eyes is located, with the body as a reference; and the second reflector (2) is located right in front of the eyes in the sight line direction; further, the reflectors are fixed by a frame which is not supported on the human body.

2. A secondary reflector, which is composed of two reflectors, follows a principle that the range of a distant object image gradually narrows from wide to a triangle and enters eyes, the reflector is set in the light incidence path to change the propagation direction of the object image; the object image (FG) first enters the (DE) part of the first reflector (1), is reflected by the first reflector (1) to the (BC) part of the second reflector (2), and is reflected into the viewpoint (A) by the second reflector (2), wherein a standard position is set as follows: a viewpoint is located near a part below a lower end point of the first reflector (1); and a connecting line between the upper and lower end points of the second reflector (2) and the viewpoint forms a golden cut triangle, that is, the connecting line from the viewpoint to the lower end point is perpendicular to the second reflector (2), with the length being twice that of the second reflector (2).

3. The secondary reflector according to claim 2, characterized in that the reflector(1) and the reflector(2) use a convex mirror and a concave mirror respectively, and further, the radians of the arc where the concave and the convex mirrors are located are equal, and further, each point of the concave-convex mirror corresponds to the incident ray on the object plane and shoots towards the viewpoint A. The secondary reflector according to claim 1, characterized in that a supporting device is disposed outside human body and an operation space.

4. The secondary reflector according to claim 1, wherein two intersecting lines of three planes of the first reflector (1), the second reflector (2) and the observed object surface are perpendicular to the center line (AH) of sight in front of the observation.

5. The secondary reflector according to claim 1, wherein the first reflector (1) is integrated with a range hood; the first reflector (1) is arranged at the outer side of a tuyere of the range hood; and the second reflector (2) is arranged below the inner side of the range hood.
